(19) United States
(12) Patent Application Publication
(10) Pub. No.: US 2025/0175285 A1
(43) Pub. Date: May 29, 2025

(54) METHOD FOR COMMUNICATION, COMMUNICATION DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Ling LYU, Shanghai (CN); Zhongzhi YANG, Shanghai (CN)

(21) Appl. No.: 19/031,044

(22) Filed: Jan. 17, 2025

Related U.S. Application Data
(63) Continuation of application No. PCT/CN2023/085547, filed on Mar. 31, 2023.

(51) Int. Cl. H04L 1/1812; H04L 1/1867; H04W 80/02

(52) U.S. Cl. CPC H04L 1/1812; H04L 1/188; H04W 80/02

(57) ABSTRACT

A method for communication, a communication device, and a network device are provided. One example method includes: receiving, by a communication device, a first data packet at a media access control (MAC) layer; and dropping, by the communication device, transmission of the first data packet at the MAC layer when a first condition is met.

### CROSS-REFERENCE TO RELATED APPLICATIONS

This application is a continuation application of and claims the benefit of priority to International Application No. PCT/CN2023/085547, filed on Mar. 31, 2023, the contents of which are hereby incorporated by reference.

### TECHNICAL FIELD

The present disclosure relates to the field of communication technology, and more specifically to a method for communication, a communication device, and a network device.

### BACKGROUND

In related technologies, when a packet data convergence protocol (PDCP) layer instructs a lower layer to delete a data packet, a radio link control (RLC) layer handles it differently depending on a processing status of the data packet. Upon receiving the packet deletion instruction from the PDCP layer, the transmitting RLC can determine whether the data packet has already been delivered to a medium access control (MAC) layer for transmission. If the data packet has already been delivered to the MAC layer, the RLC can choose not to delete it. If the packet has not yet been delivered to the MAC layer, it can be deleted from the RLC's buffer and will not be forwarded to the MAC layer for transmission.

### SUMMARY

The present disclosure provides a method for communication, a communication device, and a network device. Various aspects related to the present disclosure are described below.

According to a first aspect, a method for communication is provided, including: receiving, by a communication device, a first data packet at a media access control, MAC, layer; and dropping, by the communication device, transmission of the first data packet at the MAC layer when a first condition is met.

In some embodiments, the first data packet is associated with a first hybrid automatic repeat request, HARQ, process, and the first HARQ process is associated with a first transport block, TB; and the first condition includes that transmission of all data packets associated with the first TB requires to be dropped.

In some embodiments, the transmission of the data packets associated with the first TB requiring to be dropped includes one or both of: a current time being equal to or exceeding a first time; and receiving first indication information at the MAC layer, where the first indication information is used to indicate that the transmission of the first data packet requires to be dropped.

In some embodiments, a data packet with a latest timeout time of a delay budget among the data packets associated with the first TB is a second data packet, and the first time is determined based on a timeout time of a delay budget corresponding to the second data packet.

In some embodiments, the timeout time of the delay budget is determined based on a discard timer.

In some embodiments, the first data packet corresponds to a first HARQ entity, and the method further includes: one of the first HARQ process and the first HARQ entity performing one or both of storing and querying first information, where the first information includes one or more of the first time, a logical channel corresponding to the first data packet, and a serial number of the first data packet.

In some embodiments, the first data packet corresponds to the first HARQ entity, and the method further includes: the first HARQ entity querying a HARQ process associated with the first data packet.

In some embodiments, if the data packets associated with the first TB include a media access control control element, MAC CE, a delay budget corresponding to the MAC CE satisfies: infinity, determined by an MAC entity, or ignored.

In some embodiments, the first time is determined according to a type of the MAC CE.

In some embodiments, the first time is represented by one or both of an identifier of a time unit and an absolute time.

In some embodiments, the time unit includes one or more of a radio frame, a subframe, a slot, an orthogonal frequency division multiplexing, OFDM, symbol, and a hyper frame number.

In some embodiments, the first data packet is associated with the first HARQ process, the first HARQ process is associated with the first TB, and the method further includes: in response to receiving first indication information at the MAC layer, marking the first data packet as requiring to be dropped, where the first indication information is used to indicate that the transmission of the first data packet requires to be dropped; and where the transmission of all the data packets associated with the first TB requiring to be dropped includes that the data packets associated with the first TB are all marked as requiring to be dropped.

In some embodiments, the first data packet is forbidden to be marked as requiring to be dropped when the first data packet includes the MAC CE, or a marking status of the first data packet is ignored when determining whether the data packets associated with the first TB are all marked.

In some embodiments, the dropping the transmission of the first data packet includes dropping transmission of the first TB.

In some embodiments, the data packets associated with the first TB are transmitted from a packet data convergence protocol, PDCP, layer to the MAC layer.

In some embodiments, the method further includes: sending, by the communication device, second indication information, where the second indication information is used to indicate that the communication device drops the transmission of the first TB at the MAC layer.

In some embodiments, the second indication information is further used to indicate a HARQ process associated with the first TB.

In some embodiments, the second indication information is carried on a first resource that is allocated to the first TB.

In some embodiments, the second indication information is carried in the MAC CE.

According to a second aspect, a method for communication is provided. including: receiving, by a network device, second indication information sent by a communication device, where the second indication information is used to indicate that the communication device drops transmission of a first transport block, TB, at a media access control, MAC, layer of the communication device.

In some embodiments, the second indication information is further used to indicate a hybrid automatic repeat request, HARQ, process associated with the first TB.

In some embodiments, the second indication information is carried on a first resource that is allocated to the first TB.

In some embodiments, the second indication information is carried in a media access control control element, MAC CE.

According to a third aspect, a communication device is provided, including: a first receiving unit, configured to receive a first data packet at a media access control, MAC, layer of the communication device; and a dropping unit, configured to drop transmission of the first data packet at the MAC layer when a first condition is met.

In some embodiments, the first data packet is associated with a first hybrid automatic repeat request, HARQ, process, and the first HARQ process is associated with a first transport block, TB; and the first condition includes that transmission of all data packets associated with the first TB requires to be dropped.

In some embodiments, the transmission of all the data packets associated with the first TB requiring to be dropped includes one or both of: a current time being equal to or exceeding a first time; and receiving first indication information at the MAC layer, where the first indication information is used to indicate that the transmission of the first data packet requires to be dropped.

In some embodiments, a data packet with a latest timeout time of a delay budget among the data packets associated with the first TB is a second data packet, and the first time is determined based on a timeout time of a delay budget corresponding to the second data packet.

In some embodiments, the timeout time of the delay budget is determined based on a discard timer.

In some embodiments, the first data packet corresponds to a first HARQ entity, and the communication device is further configured as: one of the first HARQ process and the first HARQ entity performing one or both of storing and querying first information, where the first information includes one or more of the first time, a logical channel corresponding to the first data packet, and a serial number of the first data packet.

In some embodiments, the first data packet corresponds to the first HARQ entity, and the communication device is further configured as: the first HARQ entity querying a HARQ process associated with the first data packet.

In some embodiments, if the data packets associated with the first TB include a media access control control element, MAC CE, a delay budget corresponding to the MAC CE satisfies: infinity, determined by an MAC entity, or ignored.

In some embodiments, the first time is determined based on a type of the MAC CE.

In some embodiments, the first time is represented by one or both of an identifier of a time unit and an absolute time.

In some embodiments, the time unit includes one or more of a radio frame, a subframe, a slot, an orthogonal frequency division multiplexing (OFDM) symbol, and a hyper frame number.

In some embodiments, the first data packet is associated with the first HARQ process, the first HARQ process is associated with the first TB, and the communication device is further configured to: in response to receiving first indication information at the MAC layer, mark the first data packet as requiring to be dropped, where the first indication information is used to indicate that the transmission of the first data packet requires to be dropped; and where the transmission of all the data packets associated with the first TB requiring to be dropped includes that the data packets associated with the first TB are all marked as requiring to be dropped.

In some embodiments, the first data packet is forbidden to be marked as requiring to be dropped when the first data packet includes the MAC CE, or a marking status of the first data packet is ignored when determining whether the data packets associated with the first TB are all marked.

In some embodiments, the dropping the transmission of the first data packet includes dropping transmission of the first TB.

In some embodiments, the data packets associated with the first TB are transmitted from a packet data convergence protocol, PDCP, layer to the MAC layer.

In some embodiments, the communication device is further configured to send second indication information, where the second indication information is used to indicate that the communication device drops the transmission of the first TB at the MAC layer.

In some embodiments, the second indication information is further used to indicate a HARQ process associated with the first TB.

In some embodiments, the second indication information is carried on a first resource that is allocated to the first TB.

In some embodiments, the second indication information is carried in the MAC CE.

According to a fourth aspect, a network device is provided, including: a first sending unit, configured to receive second indication information sent by a communication device, where the second indication information is used to indicate that the communication device drops transmission of a first transport block, TB, at a media access control, MAC, layer of the communication device.

In some embodiments, the second indication information is further used to indicate a hybrid automatic repeat request, HARQ, process associated with the first TB.

In some embodiments, the second indication information is carried on a first resource that is allocated to the first TB.

In some embodiments, the second indication information is carried in a media access control control element, MAC CE.

According to a fifth aspect, a communication device is provided, including a processor and a memory, where the memory is configured to store one or more computer programs, and the processor is configured to invoke the one or more computer programs in the memory to cause the communication device to perform some or all of the operations in the method in the first aspect.

According to a sixth aspect, a network device is provided, including a processor, a memory, and a transceiver, where the memory is configured to store one or more computer programs, and the processor is configured to invoke the one or more computer programs in the memory to cause the network device to perform some or all of the operations in the method in the second aspect.

According to a seventh aspect, an embodiment of the present disclosure provides a communications system, where the system includes the above communication device and/or the network device. In another possible design, the system may further include another device in the solution provided in the embodiments of the present disclosure that interacts with the communication device or the network device.

According to an eighth aspect, an embodiment of the present disclosure provides a computer-readable storage medium storing a computer program, where the computer program causes a communication device and/or a network device to perform some or all of the operations in the methods in the foregoing aspects.

According to a ninth aspect, an embodiment of the present disclosure provides a computer program product, where the computer program product includes a non-transitory computer-readable storage medium storing a computer program, and the computer program is operable to cause a communication device and/or a network device to perform some or all of the operations in the methods in the foregoing aspects. In some implementations, the computer program product may be a software installation package.

According to a tenth aspect, an embodiment of the present disclosure provides a chip, where the chip includes a memory and a processor, and the processor may invoke a computer program from the memory and run the computer program, to implement some or all of the operations described in the methods in the foregoing aspects.

Based on the present disclosure, even if the first data packet is delivered to the MAC layer, the communication device may also drop the transmission of the first data packet. That is, at the MAC layer, the communication device can determine whether to stop transmitting the first data packet. This stops a corresponding hybrid automatic repeat request (HARQ) transmission in time, thereby avoiding waste of wireless communication resources and improving capacity of the communication system.

### BRIEF DESCRIPTION OF THE DRAWINGS

FIG. 1 is a schematic diagram of a wireless communication system applied in an embodiment of the present disclosure.

FIG. 2 is an exemplary diagram of a scenario of transmitting a data packet.

FIG. 3 is a schematic flowchart of a method for communication according to an embodiment of the present disclosure.

FIG. 4 is an exemplary diagram of a scenario of transmitting a data packet according to an embodiment of the present disclosure.

FIG. 5 is a schematic structural diagram of a communication device according to an embodiment of the present disclosure.

FIG. 6 is a schematic structural diagram of a network device according to an embodiment of the present disclosure.

FIG. 7 is a schematic structural diagram of an apparatus for communication according to an embodiment of the present disclosure.

### DETAILED DESCRIPTION OF THE EMBODIMENTS

The technical solutions in the present disclosure will be described below with reference to the accompanying drawings.

### Communication System

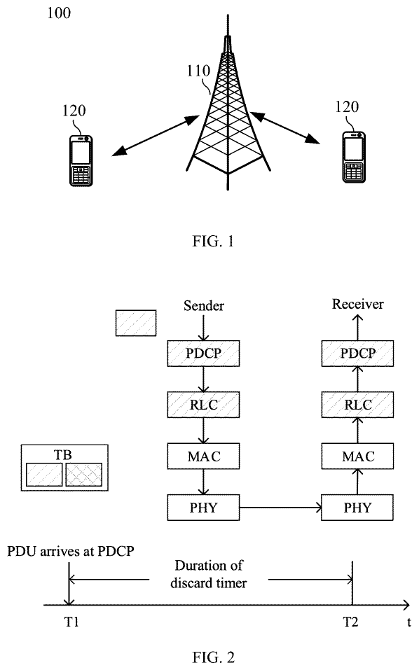

FIG. 1 is a wireless communication system 100 applied in embodiments of the present disclosure. The wireless communication system 100 includes a network device 110 and a terminal device 120, and the network device 110 may be a device that communicates with the terminal device 120. The network device 110 provides communication coverage for a particular geographic area and communicates with the terminal device 120 located within the coverage area.

FIG. 1 exemplarily shows a network device and two terminals. Optionally, the wireless communication system 100 may include a plurality of network devices, and the coverage of each network device may include other numbers of terminals, which is not limited in the embodiments of the present disclosure.

Optionally, the wireless communication system 100 may further include another network entity such as a network controller, a mobility management entity, etc., which is not limited in the embodiments of the present disclosure.

It should be understood that the technical solutions in the embodiments of the present disclosure may be applied to various communication systems, for example, a 5^{th}generation (5G) or new radio (NR) system, a long term evolution (LTE) system, an LTE frequency division duplex (FDD) system, an LTE time division duplex (TDD) system, and the like. The technical solutions provided in the present disclosure may further be applied to a future communication system such as a sixth-generation mobile communication system, a satellite communication system, or the like.

The terminal device in the embodiments of the present disclosure may also be referred to as user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user equipment. The terminal device in the embodiments of the present disclosure may be a device that provides voice and/or data connectivity to a user, and may be used to connect a person, an object, and a machine, for example, a handheld device or a vehicle-mounted device having a wireless connection function. The terminal device in the embodiments of the present disclosure may be a mobile phone, a pad, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in smart home, etc. Optionally, the UE may serve as a base station. For example, the UE may serve as a scheduling entity that provides a sidelink signal between UEs in vehicle-to-everything (V2X), device-to-device (D2D), or the like. For example, cellular phones and automobiles communicate with each other using sidelink signals. The cellular phone communicates with the smart home device without relaying communication signals through the base station.

The network device in the embodiments of the present disclosure may be a device configured to communicate with the terminal, and the network device may also be referred to as an access network device or a radio access network device, e.g., the network device may be a base station. The network device in the embodiments of the present disclosure may refer to a radio access network (RAN) node (or device) that accesses the terminal device to a wireless network. The base station may broadly cover various names in the following or be replaced with the following names. For example, a node B (NodeB), an evolved NodeB (eNB), a next generation NodeB (gNB), a relay station, an access point, a transmitting and receiving point (TRP), a transmitting point (TP), a master station (MeNB), a secondary station (SeNB), a multi-standard radio (MSR) node, a femtocell, a network controller, an access node, a wireless node, an access point (AP), a transmission node, a transceiver node, a base band unit (BBU), a remote radio unit (RRU), an active antenna unit (AAU), a remote radio unit (RRH), a central unit (CU), a distributed unit (DU), a positioning node, and the like. The base station may be a macro base station, a micro base station, a relay node, a donor node or the like, or a combination thereof. The base station may also refer to a communication module, a modem, or a chip for being disposed in the foregoing device or apparatus. The base station may also be a mobile switching center and a device that plays a role of the base station in the D2D, V2X, and machine-to-machine (M2M) communication, a network side device in a 6G network, and a device that plays a role of the base station in a future communication system, etc. The base station supports networks of the same or different access technologies. The specific technology adopted by the network device and a specific form of the device in the embodiments of the present disclosure are not limited in the embodiments of the present disclosure.

The base station may be fixed or mobile. For example, a helicopter or drone may be configured to serve as a mobile base station, and one or more cells move according to the position of the mobile base station. In other examples, a helicopter or drone may be configured to serve as a device in communication with another base station.

In some deployments, the network device in the embodiments of the present disclosure may refer to the CU or the DU, or the network device includes the CU and the DU. The gNB may also include the AAU.

The network device and the terminal device may be deployed on land, including indoor or outdoor, handheld or vehicle-mounted, may be deployed on a water surface, and may also be deployed on an aircraft, a balloon, and a satellite in the air. A scenario in which the network device and the terminal device are located is not limited in the embodiments of the present disclosure.

It should be understood that all or part of functions of the communication device in the present disclosure may also be implemented by a software function running on hardware or implemented by a virtualization function instantiated on a platform (e.g., a cloud platform).

### Extended Reality

Extended reality (XR) can be implemented using computer technology and wearable devices. XR may include representative forms such as augmented reality (AR), mixed reality (MR), and virtual reality (VR). VR technology simulates real-world objects and backgrounds using computers and presents these simulated virtual objects and backgrounds to the user. AR technology provides virtual objects on real-world imagery. MR technology combines the real world with virtual reality to provide an environment where real physical objects and virtual objects interact.

From the above introduction to XR, it is clear that XR requires high transmission rates to achieve a good user experience. With the development of wireless cellular communication technologies, wireless communication systems (such as 5G systems) are achieving increasingly higher frequency efficiency, wider usable bandwidth, and higher data transmission rates. Therefore, using wireless communication technology to support XR services is becoming increasingly feasible.

The development of XR and wireless communication networks (such as 5G networks) can mutually promote each other in a positive feedback loop. On the one hand, the development of wireless communication networks can support the development of XR. For example, a user's XR service requires a transmission rate of 30 to 200 Mbps, and a cell requires to support at least 10 terminal devices simultaneously conducting XR services. With the development of communication technology, some networks (5G networks) can provide greater transmission capacity to support the above situation. On the other hand, XR technology can also promote the development of communication services. For example, when the transmission capacity provided by the network increases significantly, mainstream services increasingly struggle to fill the network capacity, leading to idle network transmission capability. Therefore, objectively, these networks with large capacity also require new services like XR to fully utilize the network, thereby promoting their rapid growth and strengthening.

### Data Transmission Latency

A data packet, upon arrival at an access layer, must be transmitted within a data transmission latency. Failure to transmit within a duration corresponding to the data transmission latency renders this data packet meaningless to a receiver service layer.

Some communication organizations (such as the 3rd generation partnership project (3GPP)) utilize a packet delay budget (PDB) to process the data transmission latency. Specifically, when a packet data convergence protocol (PDCP) layer of a sender receives a data packet from an upper layer, the PDCP layer may initiate a corresponding discard timer with a duration equal to the PDB. When the discard timer times out, the PDCP can instruct a lower layer to delete the data packet so that the data packet is no longer transmitted.

In related technologies, when the PDCP instructs to delete the data packet, the RLC handles it differently depending on a processing status of the data packet. This is explained with reference to the scenario shown in FIG. 2. As shown in FIG. 2, the data packet enters the PDCP from the upper layer of the sender at time T1, i.e., the data packet enters the PDCP at time T1. At time T1, the PDCP starts the discard timer. This discard timer times out at time T2. At time T2, if the data packet has not been successfully transmitted, the sender's PDCP layer may instruct the RLC layer to “delete the data packet”. Upon receiving the deletion instruction, the sender's RLC entity determines whether the data packet has already been delivered to the MAC layer for transmission. If the data packet has been delivered to the MAC layer for transmission, the RLC may not delete it, and if the data packet has not yet been delivered to the MAC layer for transmission, it can be deleted from the RLC's buffer and will not be delivered to the MAC layer for transmission.

Therefore, the related technologies only delete the data packet at the RLC. If the data packet is no longer at the RLC, it cannot be deleted and will continue to be transmitted, leading to waste of wireless communication resources.

This issue is particularly prominent in XR technology. As mentioned above, XR services have a large data volume and high transmission rate requirements. Therefore, transmission resources are very scarce in XR, and even a small number of wasted resources will affect the user experience in XR technology. In this case, if the data packet is not deleted at the RLC, HARQ retransmission will continue, resulting in resource waste. For XR, this resource waste has a significant impact on communication. Therefore, addressing this issue is even more crucial for XR technology.

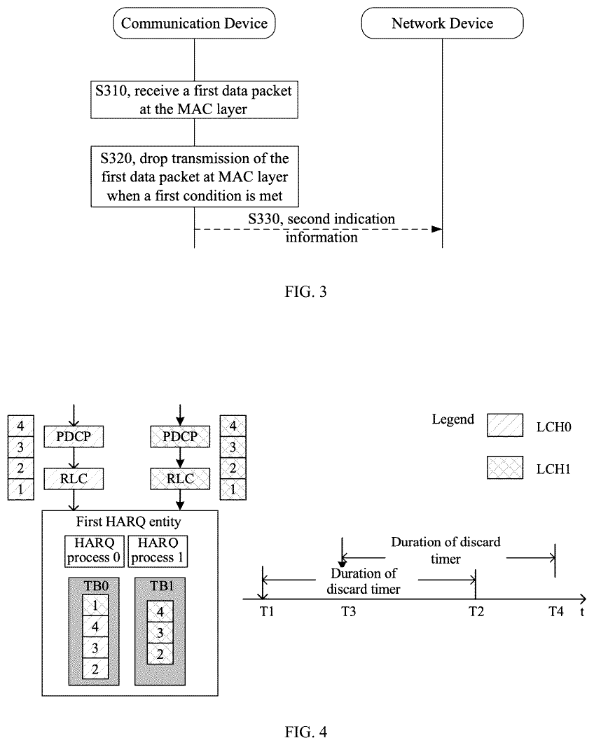

FIG. 3 is a schematic flowchart of a method for communication according to the present disclosure, to resolve the foregoing problem. The method shown in FIG. 3 may be performed by a communication device. For example, the communication device may be the terminal device or the network device described above. The method shown in FIG. 3 may include operations S310 and S320.

At operation S310, the communication device receives a first data packet at a MAC layer.

The first data packet may be delivered to the MAC layer by the PDCP layer of the communication device. The PDCP layer may deliver the first data packet to the RLC layer, and the RLC layer may deliver the first data packet to the MAC layer. At the MAC layer, the first data packet may be a medium access control service data unit (MAC SDU).

At operation S320, the communication device drops transmission of the first data packet at the MAC layer when the first condition is met.

In some embodiments, dropping the transmission of the first data packet may be referred to as stopping the transmission of the first data packet. For example, the communication device may stop retransmission of the first data packet, i.e., no longer perform the retransmission of the first data packet.

In some implementations, dropping the transmission of the first data packet at the MAC layer may include one or more of: overwriting the first data packet in a MAC buffer using another to-be-sent data packet; deleting or discarding the first data packet in the MAC buffer; filling the MAC buffer where the first data packet is located using padding; and not changing the MAC buffer, but not transmitting corresponding data in the MAC buffer.

The first condition may be a condition for dropping the transmission of the first data packet. The communication device may determine, based on the first condition, whether to drop the transmission of the first data packet. In some embodiments, the first condition may include that the first data packet requires to drop transmission. That is, in a case that the first data packet requires to drop transmission, the communication device may drop the transmission of the first data packet at the MAC layer. The case that the first data packet requires to drop the transmission may include, for example, that the first data packet has not been successfully transmitted within the data transmission latency. For example, in a case that a discard timer corresponding to the first data packet times out, transmission of the first data packet requires to be dropped. Alternatively, in a case that the PDCP layer sends an indication of “deleting the first data packet”, transmission of the first data packet requires to be dropped.

Based on the present disclosure, even if the first data packet is delivered to the MAC layer, the communication device may also drop the transmission of the first data packet. That is, the MAC layer can determine whether to stop transmitting the first data packet. This stops a corresponding HARQ transmission in time, thereby avoiding waste of wireless communication resources. In addition, the communication system may transmit other data packets that do not require to drop the transmission using the saved wireless resources, so as to transmit more useful data, thereby accommodating more users.

In some embodiments, the first data packet may be a data packet related to the XR technology. For example, the first data packet may include one or more of video data, audio data, haptic data, odor data, action data, eyeball rotation information, temperature information, humidity information, wind size information, wind direction information, and the like.

On the one hand, conventional service data packets (e.g., non-XR service data packets) typically have a relatively long PDB. This means these conventional service data packets can reside in the RLC's buffer for a relatively long duration and are quickly transmitted successfully once delivered to the MAC layer for transmission. In the event of congestion, only a small amount of data is undergoing HARQ transmission. Therefore, for the small amount of data, dropping the transmission of these data packets at the MAC layer yields limited wireless resource savings. However, after the introduction of XR technology, XR consumes significant wireless resources, making the wireless resources even more precious. Based on the present disclosure, significant wireless transmission resources are saved in XR technology. Furthermore, the communication system based on the XR technology can utilize the saved wireless resources to transmit other data packets that do not require to drop the transmission, so as to transmit more useful data, thereby accommodating more XR users.

On the other hand, data packets of the XR technology have a relatively short PDB. Consequently, these data packets initiate HARQ transmission shortly after entering the PDCP layer. That is, when the discard timer times out, the probability that the data packet has already started the HARQ transmission is relatively high. Therefore, dropping transmission of data packets that have already started HARQ processing yields substantial gains.

On another hand, due to a burst nature of the XR service, in most cases, all data packets in a same transport block (TB) originate from a same logical channel (LCH), and their corresponding discard timers time out simultaneously. Therefore, according to the present disclosure, discarding data packets that have already initiated the HARQ transmission at the MAC layer and whose discard timers have timed out is more likely to not affect the transmission of data packets from other LCHs.

In some embodiments, the first data packet may be associated with a first HARQ process, and the first HARQ process may be associated with a first TB. The first HARQ process may correspond to a first HARQ entity. Alternatively, in other words, the first data packet belongs to the first TB, and the first TB is associated with the first HARQ process. The association between the first TB and the first HARQ process may be that data packets in the first TB are in a buffer of the first HARQ process. The first condition may include that transmission of all the data packets associated with the first TB requires to be dropped. In other words, when the transmission of all the data packets associated with the first TB requires to be dropped, the communication device may drop the transmission of the first data packet at the MAC layer.

It should be noted that the data packets associated with the first TB may be all data packets in the first TB. That is, if all the data packets in the first TB require to drop the transmission, the transmission of the first data packet may be dropped. Alternatively, the data packets associated with the first TB may be part of the data packets in the first TB. The part of the data packets in the first TB may be, for example, all data packets delivered from the PDCP layer to the MAC layer in the first TB. In other words, if the data packets transmitted from the PDCP layer to the MAC layer in the first TB all require to drop the transmission, the transmission of the first data packet may be dropped.

It should be noted that dropping the transmission of the first data packet may include dropping transmission of the first TB. That is, the communication device may drop the transmission of the first data packet by dropping the transmission of the first TB.

At the MAC layer, the communication device may perform HARQ processing on the data packet. The HARQ processing may include, for example, HARQ merging. The MAC layer multiplexes data packets of various logical channels to form the TB. If a certain data packet in the TB is deleted, HARQ merging of the entire TB may be affected. Based on the foregoing consideration, the present disclosure provides the above method for deleting the first data packet, to avoid an influence on HARQ processing of the first TB on the basis of dropping the transmission of the first data packet.

The present disclosure provides some methods for determining whether the transmission of all the data packets associated with the first TB requires to be dropped. The following separately describes.

In some embodiments, if a current time is equal to or exceeding a first time, and/or first indication information is received at the MAC layer, it may be determined that the transmission of all the data packets associated with the first TB requires to be dropped. A method for determining the first time is described in detail below.

In some embodiments, the first time may be determined based on a second time. A second data packet may be a data packet with a latest timeout time of a delay budget among the data packets associated with the first TB. The second time may be a timeout time of a delay budget corresponding to the second data packet. The timeout time of the delay budget may be determined based on a timeout time of the discard timer. That is, the second time may be a timeout time of a latest timeout timer among discard timers associated with the first TB.

In some embodiments, the first time may be the second time. That is, if the current time exceeds a timeout time of a last timeout discard timer of the data packets associated with the first TB, the transmission of the first data packet may be dropped at the MAC layer. In these embodiments, the first time may also be referred to as a latest timeout time.

In some embodiments, the first HARQ process or the first HARQ entity may store and/or query first information. For example, the first information may include one or more of the first time, a logical channel corresponding to the first data packet, a serial number (SN) of the first data packet, and an identifier of the first data packet.

As an implementation, when the MAC entity generates the first TB, the first HARQ process and/or the first HARQ entity may store the first information. Taking the first information including the first time as an example, when the MAC entity generates the first TB and transmits the first TB through the first HARQ process, the first HARQ entity and/or the first HARQ process may be responsible for recording an identifier of a MAC SDU included in each TB in each HARQ process as well as a timeout time corresponding to a MAC SDU with a latest timeout timer in each MAC SDU in the first TB. Meanwhile, the first HARQ entity and/or the first HARQ process may further record an LCH and an SN corresponding to the first data packet. It should be noted that, in some embodiments, the first information may be stored in a HARQ buffer.

It should be noted that if the first HARQ process starts transmitting a new TB, the first HARQ entity and/or the first HARQ process may update the recorded first information.

In some embodiments, if the transmission of the first data packet is successful, the first HARQ process and/or the first HARQ entity may delete or overwrite the stored first information. Therefore, if the first HARQ process and/or the first HARQ entity cannot query the first information, it may be considered that the transmission of the first data packet is successful. It should be noted that if the first data packet has been successfully transmitted, the first HARQ process and/or the first HARQ entity may still be able to query the first information. This may be because the first information has not yet been overwritten by other data.

The following describes in detail with reference to the scenario shown in FIG. 4. In FIG. 4, data packets 1, 2, 3, 4 corresponding to LCH0 as well as any of the data packets 1, 2, 3, 4 corresponding to LCH0 may be the first data packet. HARQ process 0 and HARQ process 1 may both be the first HARQ process. LCH0 and LCH1 correspond to two different logical channels. Four data packets corresponding to LCH0 arrive at the PDCP simultaneously at time T1. Therefore, a PDCP entity corresponding to LCH0 starts a corresponding discard timer at time T1, which times out at time T2. Four data packets corresponding to LCH1 arrive at the PDCP simultaneously at time T3. Therefore, the PDCP entity corresponding to LCH1 starts a corresponding discard timer at time T3, which times out at time T4.

As shown in FIG. 4, a TB transmitted by HARQ process 0 includes four MAC SDUs. A timeout time of a discard timer for data packets 2, 3, and 4 corresponding to LCH0 is T2, and a timeout time of an alignment timer for a data packet 1 corresponding to LCH1 is T4. Information recorded by HARQ process 0 includes: transmitted data packets including data packets 2, 3, and 4 corresponding to LCH0, and the data packet 1 corresponding to LCH1; and the latest timeout time (i.e., the first time) being T4. Similarly, information recorded by HARQ process 1 include: transmitted data packets including data packets 2, 3, and 4 corresponding to LCH1; and the latest timeout time being T4.

In response to receiving first indication information, the first HARQ process and/or the first HARQ entity may query the first information. In a case that the first information includes the first time, the first HARQ process and/or first HARQ entity may determine, based on the queried first time, whether the current time is equal to or exceeds the first time. In a case that the first information includes the LCH and/or the SN, the first HARQ process and/or first HARQ entity may determine which HARQ process(es) correspond to the LCH and/or SN based on the queried first information, thereby determining which HARQ process(es) require to drop transmission of the corresponding data packet(s).

In some embodiments, the first indication information may be used to indicate that the transmission of the first data packet requires to be dropped. For example, the first indication information may be issued by the PDCP layer. The PDCP layer may send the first indication information to indicate “deleting the first data packet.” Upon receiving the first indication information, the RLC layer may determine whether the first data packet has been delivered to the MAC layer for transmission. If the first data packet has not been delivered to the MAC layer, the RLC layer may delete the first data packet. If the first data packet has been delivered to the MAC layer, the RLC layer may transmit the first indication information to the MAC layer.

In some embodiments, the first HARQ entity may query a HARQ process associated with the first data packet, i.e., determine which HARQ process is the first HARQ process, and thereby determining a corresponding first time based on the corresponding HARQ process.

Continuing with FIG. 4 as an example, as shown in FIG. 4, when time T2 arrives, the PDCP corresponding to LCH0 may transmit the first indication information. The first indication information may be used to instruct the RLC and MAC to “delete data packets 1, 2, 3, and 4 corresponding to LCH0”. At time T2, the RLC corresponding to LCH0 finds that all four data packets have been delivered to the MAC for processing, and therefore takes no further action. After receiving the first indication information, the MAC corresponding to LCH0 may query, based on contents stored in each HARQ process, which HARQ processes these four data packets are respectively transmitted in. Upon querying, it is found that among the four data packets, data packet 1 corresponding to LCH0 is not recorded, and data packets 2, 3, and 4 corresponding to LCH0 are transmitted in HARQ process 0. Further querying reveals that a latest timeout time of a current TB0 of HARQ process 0 is T4. Since time T4 has not yet arrived, HARQ process 0 may not drop its transmitted TB0, i.e., may not drop data packets 2, 3, and 4 corresponding to LCH0 and continue to wait for a retransmission opportunity.

With continuation reference to FIG. 4, when time T4 arrives, the PDCP corresponding to LCH1 may instruct the RLC and MAC to “delete data packets 1, 2, 3, and 4 corresponding to LCH1”. At time T4, the RLC corresponding to LCH1 finds that all four data packets have been delivered to the MAC for processing, and therefore takes no further action. After receiving the first indication information, the MAC may query, based on the first information stored in each HARQ process, which HARQ processes these four data packets are respectively transmitted in. Upon querying, it is found that among the four data packets, data packet 1 corresponding to LCH1 is transmitted in HARQ process 0, and data packets 2, 3, and 4 corresponding to LCH1 are transmitted in HARQ process 1. Since latest timeout times recorded by HARQ process 0 and HARQ process 1 are both T4, the MAC may drop the transmission of TB in HARQ process 0 and HARQ process 1 and no longer retransmit.

It should be noted that the present disclosure does not limit the representation of the first time. For example, the first time may be represented by an identifier of a time unit and/or an absolute time. The absolute time may be represented by one or more of year, month, day, hour, minute, second, millisecond, and microsecond. For example, the first time may be represented as Feb. 2, 2023, 16:58:34.304.

The time unit may include one or more of a radio frame, a subframe, a slot, an orthogonal frequency division multiplexing (OFDM) symbol, and a hyper frame number. The identifier of the time unit may be, for example, a number, an ID, or etc. of the time unit. That is, the first time may be represented by one or more of a radio frame number, a subframe number, a slot number, and an OFDM symbol.

In some embodiments, the data packets associated with the first TB may include data packets not delivered by the PDCP. For example, the data packets associated with the first TB may include a medium access control control element (MAC CE), a radio link control (RLC) status report, a PDCP control element, etc. In this case, a delay budget corresponding to a data packet not delivered by the PDCP may satisfy: determined (or specified) by the MAC entity, infinity, or ignored. It should be noted that when the delay budget corresponding to the data packet not delivered by the PDCP is ignored, it may be considered that the data packet does not have a corresponding delay budget, i.e., the delay budget corresponding to the data packet may not be considered when determining the first time. As an implementation, the delay budget or a timeout time of the delay budget corresponding to the MAC CE may be determined by the MAC entity. Alternatively, the delay budget corresponding to the MAC CE may be infinite. Alternatively, the delay budget corresponding to the MAC CE may be ignored.

As an implementation, the delay budget, or the timeout time of the delay budget corresponding to the MAC CE determined by the MAC entity may be configured according to a type of the MAC CE. Furthermore, the delay budget or the timeout time of the delay budget corresponding to the MAC CE determined by the MAC entity may be configured by radio resource control (RRC) signaling.

The foregoing describes a method for determining whether the transmission of all the data packets associated with the first TB requires to be dropped based on the first time. The following describes a method for determining whether the transmission of all the data packets associated with the first TB requires to be dropped based on marking.

In some embodiments, in response to receiving the first indication information at the MAC layer, the communication device may mark the first data packet as requiring to be dropped. If the data packets associated with the first TB are all marked as requiring to be dropped, the communication device may drop the transmission of the first data packet at the MAC layer. That is, if the MAC layer receives an indication that the data packets associated with the first TB are all marked as requiring to be dropped, the transmission of the first data packet may be dropped.

It should be noted that the present disclosure does not limit the specific manner of marking as requiring to be dropped. For example, a first identifier may be used to mark a data packet as requiring to be dropped, and a second identifier may be used to mark a data packet as not requiring to be dropped. Alternatively, the first data packet requires to be dropped if it is marked with the first identifier, and it does not require to be dropped if it is not marked with the first identifier.

In some embodiments, the HARQ entity may query a HARQ process associated with the first data packet, i.e., determine which HARQ process is the first HARQ process, so as to determine a marking status of the data packet based on the corresponding HARQ process.

The following describes in detail with reference to the scenario shown FIG. 4. After the initial transmission of two TBs, the MAC may record that the data packets transmitted by the HARQ process 0 includes the data packets 2, 3, 4 of LCH0 and the data packet 1 of LCH1; and the data packets transmitted by the HARQ process I includes the data packets 2, 3, 4 of LCH1. When time T2 arrives, if the MAC layer receives the first indication information of the PDCP entity corresponding to LCH0 and the first indication information indicates deleting the data packets 1, 2, 3, and 4 of LCH0, the MAC may query the transmission status of the four data packets. As shown in FIG. 4, in the four data packets, the data packet 1 of LCH0 has been successfully transmitted, and the data packets 2, 3, and 4 of LCH0 have not been successfully transmitted and are stored in the buffer of HARQ process 0. The MAC may mark the corresponding data packets as required to be “deleted” in parentheses, and the marking status may be: data packets transmitted by the HARQ process 0, data packets 2 (deleted), 3 (deleted), 4 (deleted) of LCH0, and the data packet 1 of LCH1; and the data packets transmitted by the HARQ process 1, and the data packet 2, 3, and 4 of LCH1 not marked as required to be dropped. Then, the MAC may determine whether to retransmit or drop the transmission of the TB or the corresponding data packets according to whether the MAC SDUs in the TB have all been marked as “deleted”. If the MAC SDUs in one TB have all been marked as “deleted,” the MAC layer may not retransmit the TB or delete the TB. If not all MAC SDUs in the TB are marked as “deleted”, the transmission of the TB is not dropped and HARQ retransmission is still performed. Since the data packet 1 of LCH1 in the TB in the HARQ process 0 has not been marked as required to be dropped. Therefore, TB0 is not deleted at time T2.

At time T4, the MAC receives a PDCP entity notification corresponding to LCH1. The notification indicates to delete the data packets 1, 2, 3, 4 of LCH1. In this case, the MAC queries the four data packets, the data packet 1 corresponding to LCH1 is in the buffer of the HARQ process 0, and the data packets 2, 3, and 4 of LCH1 are in the buffer of the HARQ process 1. Based on this, the MAC may change the record to: the data packets transmitted by the HARQ process 0 including data packets 2 (deleted), 3 (deleted), 4 (deleted), and the data packet 1 (deleted) of LCH1; and the data packet transmitted by the HARQ process 1 including data packets 2 (deleted), 3 (deleted), and 4 (deleted) of LCH1.

Since all MAC SDUs within the TBs in HARQ processes 0 and 1 are marked as requiring to be dropped, the MAC layer may delete these two TBs from the buffer of HARQ and not retransmit them. Alternatively, the MAC may not delete these two TBs from the buffer of HARQ, but the communication device does not transmit these two TBs over an air interface.

In some embodiments, for data packets not delivered by the PDCP, the MAC layer may ignore the marking status of these data packets, or the MAC layer may default these data packets are all marked as requiring to be dropped. For example, if the first data packet is a data packet containing the MAC CE, the marking data of the MAC CE may be disregarded. That is, as long as all MAC SDUs other than the MAC CE in the first TB have been marked as requiring to be dropped, the transmission of the first TB may be dropped at the MAC layer, and thus the transmission of the first data packet may be dropped at the MAC layer. Alternatively, in the MAC SDUs included in the first TB, the transmission of the first TB may be dropped if all data originating from the PDCP is marked as requiring to be dropped, regardless of the marking statuses of other types of MAC SDUs. Other types of MAC SDUs may include, but are not limited to, MAC CE, RLC status reports, and PDCP control units.

In some embodiments, data packets not delivered by the PDCP may be prohibited from being marked as requiring to be dropped. For example, if the first data packet contains the MAC CE, the first data packet containing the MAC CE is by default not marked as requiring to be dropped. Therefore, the transmission of the first packet will not be dropped.

In some embodiments, the method illustrated in FIG. 3 may further include operation S330. At operation S330, the communication device may transmit second indication information. Correspondingly, the network device may receive the second indication information.

The second indication information may be used to indicate that the communication device drops the transmission of the first TB at the MAC layer of the communication device.

When the communication device is a terminal device, the terminal device may receive an uplink resource allocated by the network device. The uplink resource may be used to retransmit the first TB of which the transmission has been dropped. In this case, the terminal device may transmit the second indication information to inform the network device that the transmission of the first TB has been dropped, so that the network device does not allocate a corresponding uplink resource for the first TB, thereby saving transmission resources.

As an implementation, the second indication information may be carried on a first resource. The first resource may be the resource allocated for the first TB. That is, the first resource may be the resource allocated for the first TB of which the transmission has been dropped. Since the first resource, already allocated for the first TB, is no longer required to transmit the first data packet, using the first resource to transmit the second indication information avoids wasting the first resource. It should be noted that the first resource may also be other uplink resources. That is, the second indication information may be transmitted on other uplink resources.

It should be noted that if the transmission of the first data packet is not dropped, the second indication information may not be generated, thereby saving communication overhead.

The present disclosure does not limit a type of the message carrying the second indication information. For example, the second indication information may be carried in the MAC CE. Compared to a message generated by, for example, the PDCP, the MAC CE has a faster response time. Therefore, based on the MAC CE, the terminal device can more quickly indicate to the network device that the transmission of the first TB has been dropped, allowing the network device to stop scheduling retransmission of the first TB as soon as possible, thereby avoiding resource waste.

The method embodiments of the present disclosure have been described in detail above. The following describes the apparatus embodiments of the present disclosure in detail. It should be understood that the descriptions of the method embodiments and the apparatus embodiments correspond to each other, and therefore, portions not described in detail may refer to the preceding method embodiments.

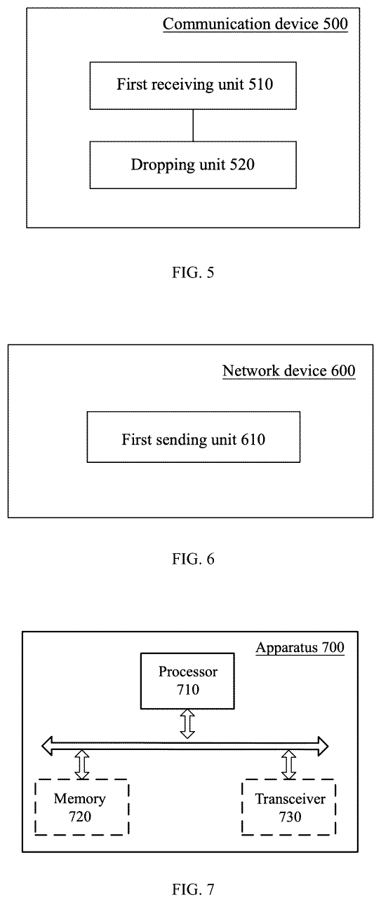

FIG. 5 is a schematic structural diagram of a communication device 500 according to an embodiment of the present disclosure. The communication device 500 may include a first receiving unit 510 and a dropping unit 520.

The first receiving unit 510 is configured to receive a first data packet at a media access control (MAC) layer of a communication device.

The dropping unit 520 is configured to drop transmission of the first data packet at the MAC layer when a first condition is met.

In some embodiments, the first data packet is associated with a first hybrid automatic repeat request (HARQ) process, and the first HARQ process is associated with a first transport block (TB).

In some embodiments, the transmission of all the data packets associated with the first TB requiring to be dropped includes: the current time being equal to or exceeding a first time; and/or, receiving first indication information at the MAC layer, where the first indication information is used to indicate that the transmission of the first data packet requires to be dropped.

In some embodiments, a data packet with a latest timeout time of a delay budget among the data packets associated with the first TB is a second data packet, and the first time is determined based on a timeout time of a delay budget corresponding to the second data packet.

In some embodiments, the timeout time of the delay budget is determined based on a discard timer.

In some embodiments, the first data packet corresponds to a first HARQ entity, and the communication device is further configured as: the first HARQ process or the first HARQ entity stores and/or queries first information, where the first information includes one or more of the first time, a logical channel corresponding to the first data packet, and a serial number of the first data packet.

In some embodiments, the first data packet corresponds to the first HARQ entity, and the communication device is further configured as: the first HARQ entity querying a HARQ process associated with the first data packet.

In some embodiments, if the data packets associated with the first TB include a media access control control element (MAC CE), a delay budget corresponding to the MAC CE satisfies: infinity, determined by an MAC entity, or ignored. MAC CE.

In some embodiments, the first time is determined according to a type of the

In some embodiments, the first time is represented by an identifier of the time unit and/or an absolute time.

In some embodiments, the time unit includes one or more of a radio frame, a subframe, a slot, an OFDM symbol, and a hyper frame number.

In some embodiments, the first data packet is associated with the first HARQ process, the first HARQ process is associated with the first TB, and the communication device is further configured to: in response to receiving first indication information at the MAC layer, mark the first data packet as requiring to be dropped, where the first indication information is used to indicate that transmission of the first data packet requires to be dropped. The transmission of all the data packets associated with the first TB requiring to be dropped includes that the data packets associated with the first TB are all marked as requiring to be dropped.

In some embodiments, the first data packet is forbidden to be marked as requiring to be dropped when the first data packet includes the MAC CE, or a marking status of the first data packet is ignored when determining whether the data packets associated with the first TB are all marked.

In some embodiments, the dropping the transmission of the first data packet includes dropping the transmission of the first TB.

In some embodiments, the data packets associated with the first TB are transmitted from a packet data convergence protocol (PDCP) layer to the MAC layer.

In some embodiments, the communication device is further configured to: send second indication information, where the second indication information is used to indicate that the communication device drops the transmission of the first TB at the MAC layer.

In some embodiments, the second indication information is further used to indicate a HARQ process associated with the first TB.

In some embodiments, the second indication information is carried on a first resource that is allocated to the first TB.

In some embodiments, the second indication information is carried in the MAC CE.

FIG. 6 is a schematic structural diagram of a network device 600 according to an embodiment of the present disclosure. The network device 600 may include a first sending unit 610.

The network device 600 includes a first sending unit, configured to receive second indication information sent by a communication device, where the second indication information is used to indicate that the communication device drops transmission of a first TB at the MAC layer of the communication device.

In some embodiments, the second indication information is further used to indicate a HARQ process associated with the first TB.

In some embodiments, the second indication information is carried on a first resource that is allocated to the first TB.

In some embodiments, the second indication information is carried in the MAC CE.

In an optional embodiment, the first sending unit 610 may be a transceiver 730, the first receiving unit 510 or the dropping unit 520 may be the processor 710. The communication device 500 may further include a memory 720 and a transceiver 730, and the network device 600 may further include the processor 710 and the memory 720, as shown in FIG. 7.

FIG. 7 is a schematic structural diagram of an apparatus for communication according to an embodiment of the present disclosure. The dashed line in FIG. 7 indicates that the unit or module is optional. The apparatus 700 may be configured to implement the method described in the foregoing method embodiments. The apparatus 700 may be one or more of a chip, a terminal device, or a network device.

The apparatus 700 may include one or more processors 710, and the processor 710 may support the apparatus 700 to implement the method described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or other programmable logic devices, a discrete gate or transistor logic device, a discrete hardware component, or the like. The general-purpose processor may be a microprocessor, or the processor may be any conventional processor or the like.

The apparatus 700 may further include one or more memories 720 storing a program, and the program may be executed by the processor 710 to cause the processor 710 to perform the method described in the foregoing method embodiments. The memory 720 may be independent of the processor 710 or may be integrated into the processor 710.

The apparatus 700 may further include a transceiver 730, and the processor 710 may communicate with another device or chip via the transceiver 730. For example, the processor 710 may perform data transceiving with another device or chip via the transceiver 730.

Embodiments of the present disclosure further provide a computer-readable storage medium, configured to store a program. The computer-readable storage medium may be applied to the terminal or network device provided in the embodiments of the present disclosure, and the program causes the computer to perform the method performed by the terminal or network device in the embodiments of the present disclosure.

Embodiments of the present disclosure further provide a computer program product. The computer program product includes a program. The computer program product may be applied to the terminal or network device provided in the embodiments of the present disclosure, and the program causes the computer to perform the method performed by the terminal or network device in the embodiments of the present disclosure.

Embodiments of the present disclosure further provide a computer program. The computer program may be applied to the terminal or network device provided in the embodiments of the present disclosure, and the computer program causes the computer to perform the method performed by the terminal or network device in the embodiments of the present disclosure.

It should be understood that the terms “system” and “network” may be used interchangeably in the present disclosure. In addition, the terms used in the present disclosure are intended only to explain specific embodiments of the present disclosure and are not intended to limit the present disclosure. The terms “first”, “second”, “third” and “fourth” in the description and claims as well as the accompanying drawings of the present disclosure are used to distinguish between different objects and not to describe a particular order. Furthermore, the terms “including” and “having”, and any variation thereof, are intended to cover non-exclusive inclusion.

In the embodiments of the present disclosure, the term “indication” mentioned in the embodiments of the present disclosure may be a direct indication, or may be an indirect indication, or may indicate that there is an association relationship. For example, A indicates B, which may indicate that A directly indicates B, e.g., B is obtained through A, or may indicate that A indirectly indicates B, e.g., A indicates C and B is obtained through C, or may indicate that A and B have an association relationship.

In the embodiments of the present disclosure, “B corresponding to A” indicates that B is associated with A, and B may be determined based on A. However, it should be further understood that, determining B based on A does not mean that B is determined only based on A, or B may also be determined based on A and/or other information.

In the embodiments of the present disclosure, the term “corresponding” in the embodiments of the present disclosure may indicate that there is a direct correspondence or indirect correspondence between the two, or may indicate that there is an association relationship between the two, or may be relationships such as indicating and being indicated, configuring and being configured, etc.

In the embodiments of the present disclosure, the terms “predefined” and “preconfigured” may be implemented by pre-storing a corresponding code, a table, or another manner that can be used to indicate related information in a device (e.g., a terminal device and a network device), and a specific implementation is not limited in the present disclosure. For example, the predefined may indicate being defined in a protocol.

In the embodiments of the present disclosure, the term “protocol” in the embodiments of the present disclosure may refer to a standard protocol in the field of communications, such as an LTE protocol, an NR protocol, and related protocols applied to a future communications system, which is not limited in the present disclosure.

In the embodiments of the present disclosure, the term “and/or” in this specification is merely an association relationship for describing associated objects, indicating that there are three relationships, e.g., A and/or B may indicate that A exists alone, A and B exist at the same time, and B exists alone. In addition, the character “/” in this specification generally indicates an “or” relationship between the associated objects.

In the embodiments of the present disclosure, “including” may indicate either directly or indirectly. Optionally, references to “including” in embodiments of the present disclosure may be replaced with “indicating” or “used to determine”. For example, A including B may be replaced with A indicating B, or A used to determine B.

In the embodiments of the present disclosure, in various embodiments of the present disclosure, a size of a serial number of each process does not mean an execution sequence, and the execution sequence of each process should be determined by its function and internal logic but should not constitute any limitation on an implementation process of the embodiments of the present disclosure.

In the several embodiments provided in the present disclosure, it should be understood that the disclosed system, apparatus, and method may be implemented in other manners. For example, the apparatus embodiments described above are merely illustrative, and the division of the units is merely a logical function division. In actual implementation, there may be alternative division manners, such as combining a plurality of units or components or integrating them into another system, or ignoring or not executing some features. In addition, the shown or discussed mutual coupling or direct coupling or communication connection may be indirect coupling or communication connection through some interfaces, devices, or units, which may be electrical, mechanical, or in other forms.

The units described as separate parts may or may not be physically separate, and parts shown as units may or may not be physical units, i.e., may be located in one position, or may be distributed on a plurality of network units. Some or all of the units may be selected according to actual requires to achieve the objectives of the solutions of the embodiments.

In addition, functional units in the embodiments of the present disclosure may be integrated into one processing unit, or each of the units may exist alone physically, or two or more units are integrated into one unit.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium, for example, the computer instructions may be transmitted from a website, a computer, a server, or a data center to another website, computer, server, or data center in a wired (e.g., a coaxial cable, an optical fiber, a digital subscriber line (DSL)) or a wireless (e.g., infrared, wireless, microwave, etc.) manner. The computer-readable storage medium may be any usable medium readable by a computer, or a data storage device, such as a server or a data center including one or more integrated usable media. The usable medium may be a magnetic medium (e.g., a floppy disk, a hard disk, or a magnetic tape), an optical medium (e.g., a digital video disk (DVD)), a semiconductor medium (e.g., a solid state disk (SSD)), or the like.

The foregoing descriptions are merely specific implementations of the present disclosure, but the protection scope of the present disclosure is not limited thereto, and any changes or substitutions may be easily conceived of by a person skilled in the art within the technical scope disclosed in the present disclosure. Therefore, the protection scope of the present disclosure shall be subject to the protection scope of the claims.

What is claimed is:

1. A method for communication, comprising:
receiving, by a communication device, a first data packet at a media access control (MAC) layer; and
dropping, by the communication device, transmission of the first data packet at the MAC layer when a first condition is met.

2. The method according to claim 1, wherein the first data packet is associated with a first hybrid automatic repeat request (HARQ) process, and the first HARQ process is associated with a first transport block (TB), and wherein the first condition includes that transmission of all data packets associated with the first TB requires to be dropped.

3. The method according to claim 2, wherein the transmission of all the data packets associated with the first TB requiring to be dropped includes at least one of:
a current time being equal to or exceeding a first time; or
first indication information being received at the MAC layer, wherein the first indication information indicates that the transmission of the first data packet requires to be dropped.

4. The method according to claim 3, wherein a data packet with a latest timeout time of a delay budget among the data packets associated with the first TB is a second data packet, and the first time is determined based on a timeout time of a delay budget corresponding to the second data packet.

5. The method according to claim 4, wherein the timeout time of the delay budget is determined based on a discard timer.

6. The method according to claim 3, wherein the first data packet corresponds to a first HARQ entity, and the method further comprises:
one of the first HARQ process and the first HARQ entity performing one or both of storing or querying first information;
wherein the first information includes at least one of the first time, a logical channel corresponding to the first data packet, or a serial number of the first data packet.

7. The method according to claim 6, wherein the first data packet corresponds to the first HARQ entity, and the method further comprises:
the first HARQ entity querying a HARQ process associated with the first data packet.

8. The method according to claim 4, wherein the data packets associated with the first TB include a media access control control element (MAC CE), a delay budget corresponding to the MAC CE satisfies at least one of: infinity, determined by an MAC entity, or ignored.

9. The method according to claim 8, wherein the first time is determined based on a type of the MAC CE.

10. The method according to claim 3, wherein the first time is represented by at least one of an identifier of a time unit or an absolute time.

11. The method according to claim 10, wherein the time unit includes at least one of a radio frame, a subframe, a slot, an orthogonal frequency division multiplexing, OFDM, symbol, or a hyper frame number.

12. The method according to claim 2, wherein the first data packet is associated with the first HARQ process, the first HARQ process is associated with the first TB, and the method further comprises:
in response to receiving first indication information at the MAC layer, marking the first data packet as requiring to be dropped, wherein the first indication information indicates that the transmission of the first data packet requires to be dropped; and
wherein the transmission of all the data packets associated with the first TB requiring to be dropped includes that the data packets associated with the first TB being all marked as requiring to be dropped.

13. The method according to claim 12, wherein the first data packet is forbidden to be marked as requiring to be dropped when the first data packet includes the MAC CE, or a marking status of the first data packet is ignored when determining whether the data packets associated with the first TB are all marked.

14. The method according to claim 2, wherein dropping the transmission of the first data packet includes dropping transmission of the first TB.

15. The method according to claim 2, wherein the data packets associated with the first TB are transmitted from a packet data convergence protocol (PDCP) layer to the MAC layer.

16. The method according to claim 14, further comprising:
sending, by the communication device, second indication information, wherein the second indication information indicates that the communication device drops the transmission of the first TB at the MAC layer.

17. The method according to claim 16, wherein the second indication information indicates a HARQ process associated with the first TB.

18. The method according to claim 16, wherein the second indication information is carried on a first resource that is allocated to the first TB.

19. The method according to claim 16, wherein the second indication information is carried in the MAC CE.

20. A method for communication, comprising:
receiving, by a network device, second indication information sent by a communication device;
wherein the second indication information indicates that the communication device drops transmission of a first transport block (TB) at a media access control (MAC) layer of the communication device.
